(19) United States
(12) Patent Application Publication
(10) Pub. No.: US 2025/0351967 A1
(43) Pub. Date: Nov. 20, 2025

(54) SEAT PAD AND MOLD FOR SEAT PAD

(71) Applicant: TOYOTA BOSHOKU KABUSHIKI KAISHA, Aichi-ken (JP)

(72) Inventor: Satoru OHIRA, Aichi-ken (JP)

(73) Assignee: TOYOTA BOSHOKU KABUSHIKI KAISHA, Aichi-ken (JP)

(21) Appl. No.: 19/194,831

(22) Filed: Apr. 30, 2025

(30) Foreign Application Priority Data
May 15, 2024 (JP) 2024-079253

(51) Int. Cl. A47C 7/18; B29C 45/14; B29C 45/26; B29L 31/00; B60N 2/56; B60N 2/70

(52) U.S. Cl. CPC A47C 7/18; B29C 45/14065; B29C 45/26; B29C 2045/14122; B29L 2031/771; B60N 2/5621; B60N 2/7017

(57) ABSTRACT

A seat pad includes: a pad body including an air flow passage; a duct configured to form an inner peripheral wall of the air flow passage; and a flow passage cover configured to cover the air flow passage. The duct and the flow passage cover are configured to be foamed and molded integrally with the pad body. The flow passage cover has a cover bent portion bent toward a seat front side to form a recess capable of receiving a bank portion that protrudes from the molding surface. The duct includes a seat surface portion extending along a region of the pad back surface which is outside the air flow passage, and with respect to the flow passage cover, the seat surface portion is configured to be brought into contact with a protruding tip end of the cover bent portion to form a gap.

### CROSS-REFERENCE TO RELATED APPLICATIONS

This application is based on and claims priority under 35 USC § 119 from Japanese Patent Application No. 2024-079253 filed on May 15, 2024, the contents of which are incorporated herein by reference.

### TECHNICAL FIELD

The present invention relates to a seat pad and a mold for the seat pad. More specifically, the present invention relates to a seat pad including an air flow passage formed on a pad back surface and a flow passage cover that covers the air flow passage from a seat back side, and a mold for the seat pad.

### BACKGROUND

Patent Literature 1 discloses a seat back including a recessed air flow passage extending along a pad back surface. The seat back includes a duct that is integrally molded with a pad body and forms an inner peripheral wall of the air flow passage, and a planar flow passage cover that covers the air flow passage from a seat back side. The flow passage cover covers, from the seat back side, the duct integrally molded with the pad body. The flow passage cover is held in a state of covering the air flow passage by being adhered to the duct using an adhesive.
Patent Literature 1: JP2013-100000A

As in the above literature, when the flow passage cover is assembled to the molded pad body from rear, the flow passage cover may be misaligned with respect to an alignment position with the duct. In this case, ventilation performance of the seat pad may deteriorate.

Therefore, for example, it is contemplated to integrally mold the flow passage cover and the duct with the pad body. However, a foaming raw material may leak from a gap between a peripheral edge portion of the flow passage cover and a molding surface or a gap between the flow passage cover and the duct to cause a molding failure. Therefore, an object of the present invention is to provide a seat pad in which a flow passage cover and a duct can be appropriately and integrally molded with a pad body while preventing leakage of a foaming raw material, and a mold for the seat pad.

### SUMMARY

In order to solve the above problem, a seat pad and a mold for the seat pad according to the present invention take the following measures.

A seat pad includes: a pad body including a recessed air flow passage extending along a pad back surface; a planar duct configured to be provided along the pad back surface to form an inner peripheral wall of the air flow passage; and a planar flow passage cover configured to cover the duct from a seat back side and configured to cover the air flow passage. The duct and the flow passage cover are molded in predetermined shapes in advance, and are configured to be foamed and molded integrally with the pad body. The flow passage cover is configured to be set on a molding surface of a mold for the pad body in an overlapping manner, and has a cover bent portion bent toward a seat front side to form, at a peripheral edge portion of the flow passage cover, a recess capable of receiving a bank portion that protrudes from the molding surface. The duct includes a seat surface portion extending along a region of the pad back surface which is outside the air flow passage, and with respect to the flow passage cover to be set on the molding surface, the seat surface portion is configured to be brought into contact with a protruding tip end of the cover bent portion to form a gap into which a foaming raw material of the pad body is to flow.

In the seat pad according to above aspect, the seat surface portion includes a duct bent portion that is on an inner side in an in-plane direction with respect to the cover bent portion and that is bent to protrude toward the seat back side to be brought into contact with the flow passage cover.

In the seat pad according to above aspect, the cover bent portion extends in an endless manner over an entire peripheral edge of the flow passage cover.

In the seat pad according to above aspect, the flow passage cover includes a support portion protruding into the air flow passage to be brought into contact, from the seat back side, with a bottom portion that forms a bottom surface of the air flow passage of the duct.

A mold for molding the seat pad according to above aspect includes: an engagement portion configured to protrude from the bank portion and configured to pass through through holes formed in the tip end of the cover bent portion and the seat surface portion to engage with the seat surface portion so as to press the base end of the cover bent portion against the molding surface against a resilient force of the cover bent portion.

A mold for molding the seat pad according to above aspect, the bank portion is provided at an interval from the cover bent portion so as not to interfere with the cover bent portion in an initial state in which the flow passage cover is set.

### BRIEF DESCRIPTION OF DRAWINGS

FIG. 1 is a perspective view of a seat cushion according to a first embodiment.

FIG. 2 is a perspective view of the seat cushion when viewed from below.

FIG. 3 is a perspective view when a flow passage cover is disassembled from a cushion pad.

FIG. 4 is a perspective view when a duct is disassembled from the cushion pad.

FIG. 5 is a perspective view of the flow passage cover and the duct when viewed from rear.

FIG. 6 is an enlarged view of a portion VI in FIG. 5.

FIG. 7 is a plan view of the seat cushion.

FIG. 8 is a cross-sectional view taken along line VIII-VIII in FIG. 7.

FIG. 9 is a cross-sectional view taken along line IX-IX in FIG. 7.

FIG. 10 is a schematic view of a mold corresponding to a cross section in FIG. 8.

FIG. 11 is a schematic view of the mold corresponding to a cross section in FIG. 9.

FIG. 12 is an enlarged view of a portion XII in FIG. 10.

FIG. 13 is an enlarged view of a portion XIII in FIG. 11.

FIG. 14 is a view showing a modification of a hole forming protrusion and corresponding to the enlarged view in FIG. 12.

### DESCRIPTION OF EMBODIMENTS

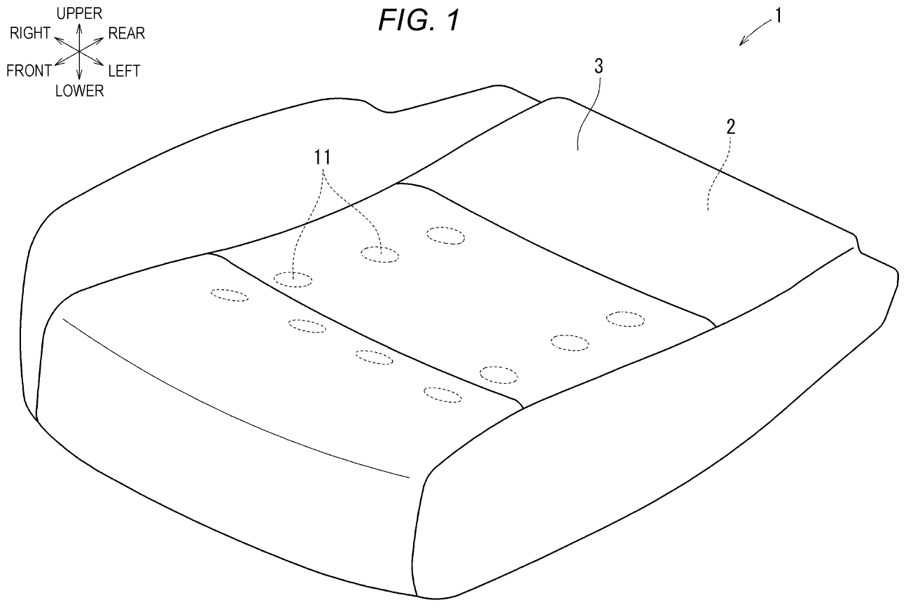

Hereinafter, embodiments of the present invention will be described with reference to FIGS. 1 to 14. In the following description, when a direction such as front, rear, upper, lower, left, or right is described, it is assumed that the direction indicates a corresponding direction shown in the drawings. When a “seat width direction” is described, it is assumed that the “seat width direction” indicates a left-right direction of a seat cushion 1 described later.

### First Embodiment

First, a seat pad according to a first embodiment of the present invention will be described. As shown in FIG. 1, a seat pad includes a cushion pad 2 that forms a cushion material of the seat cushion 1. The seat cushion 1 forms a seating portion of a seat for an automobile. The seat cushion 1 has a plurality of vent holes 11 penetrating the inside of the cushion pad 2 in a thickness direction (upper-lower direction). Each vent hole 11 can allow the inside of the cushion pad 2 to be easily ventilated.

The seat cushion 1 includes a blower (not shown) disposed below the cushion pad 2. The blower is fluidly connected to the vent hole 11, sucks air from the vent hole 11, and exhausts the air downward of the seat cushion 1. As described above, the seat cushion 1 has a seat air-conditioning function of actively ventilating the inside of the cushion pad 2. Accordingly, comfort of the seat cushion 1 can be improved by actively removing heat in the cushion pad 2.

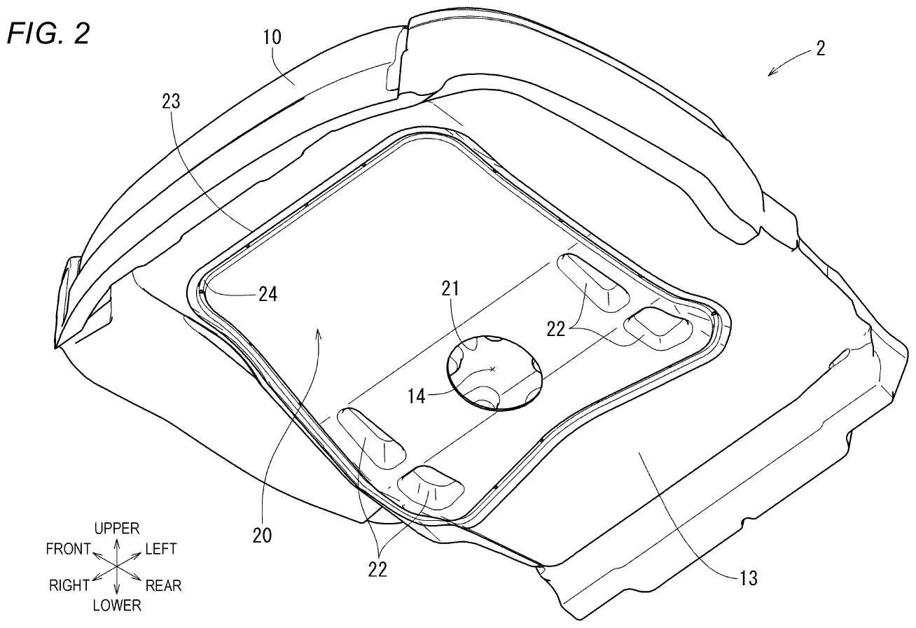

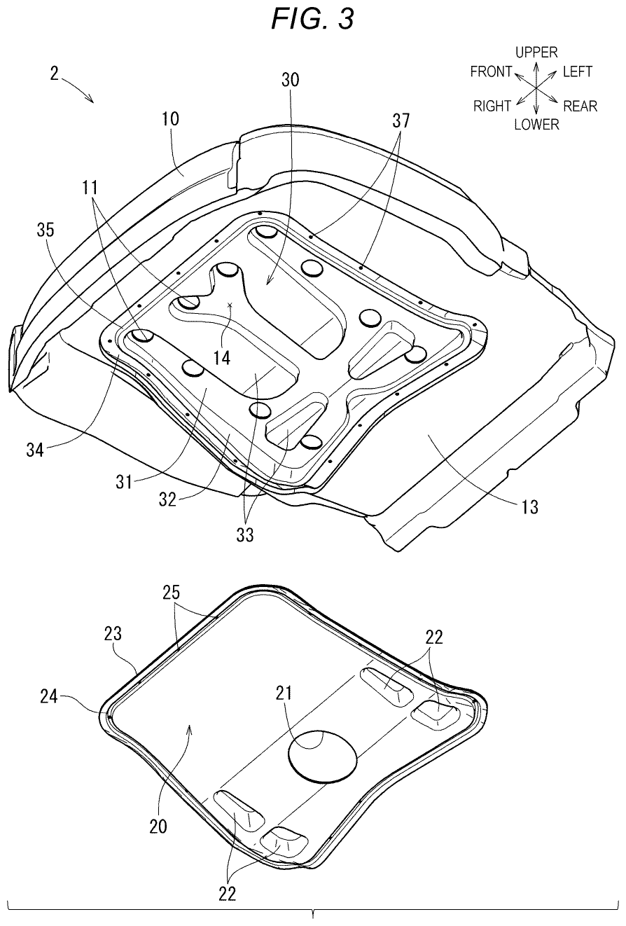

As shown in FIGS. 2 and 3, the cushion pad 2 includes a pad body 10 that elastically supports buttocks of a seated person, and a recessed air flow passage 14 that extends along a pad back surface 13 of the pad body 10. The air flow passage 14 opens toward a seat back side.

The vent hole 11 opens from various places in the air flow passage 14. The cushion pad 2 includes a planar flow passage cover 20 provided along the pad back surface 13 to cover the air flow passage 14 from the seat back side. The flow passage cover 20 closes an opening of the air flow passage 14 toward the seat back side. The flow passage cover 20 has an opening hole 21 that opens in a circular shape from a center of a rear portion of the flow passage cover 20. The opening hole 21 is connected to the blower. Therefore, the air sucked from the vent hole 11 flows along the air flow passage 14 and is exhausted to the seat back side through the opening hole 21.

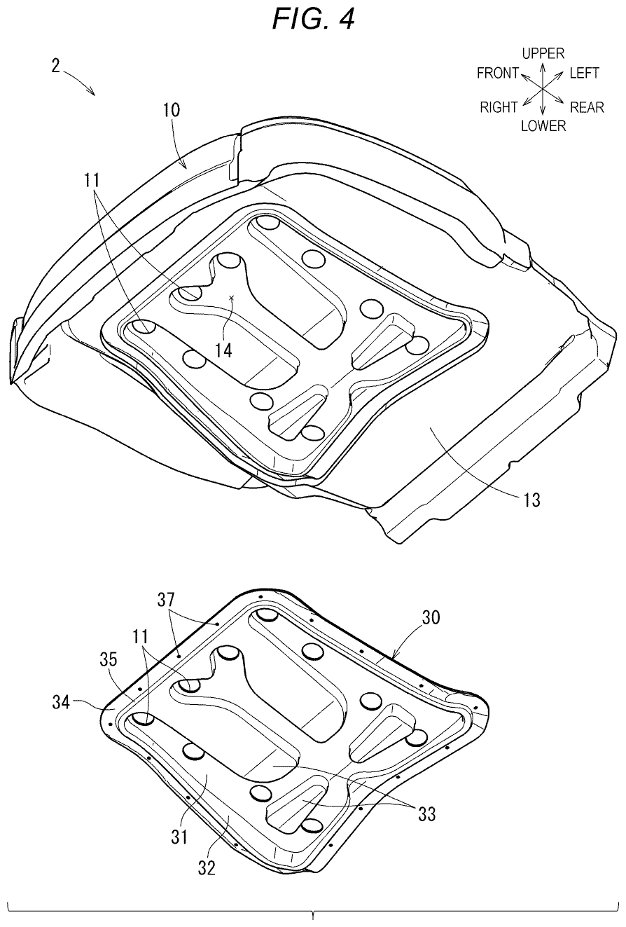

As shown in FIGS. 3 and 4, the cushion pad 2 includes a planar duct 30 provided along the pad back surface 13 to form an inner peripheral wall of the air flow passage 14. The duct 30 is a molded nonwoven fabric that is press-molded into a predetermined shape in advance. The duct 30 is harder than the pad body 10. Therefore, a strength of the air flow passage 14 can be increased by the duct 30. Therefore, when a seating load is applied to the cushion pad 2, a shape of the air flow passage 14 can be maintained so as not to be crushed. Accordingly, a flow of an air flowing through the air flow passage 14 is less likely to be obstructed, and deterioration of the seat air-conditioning function can be prevented.

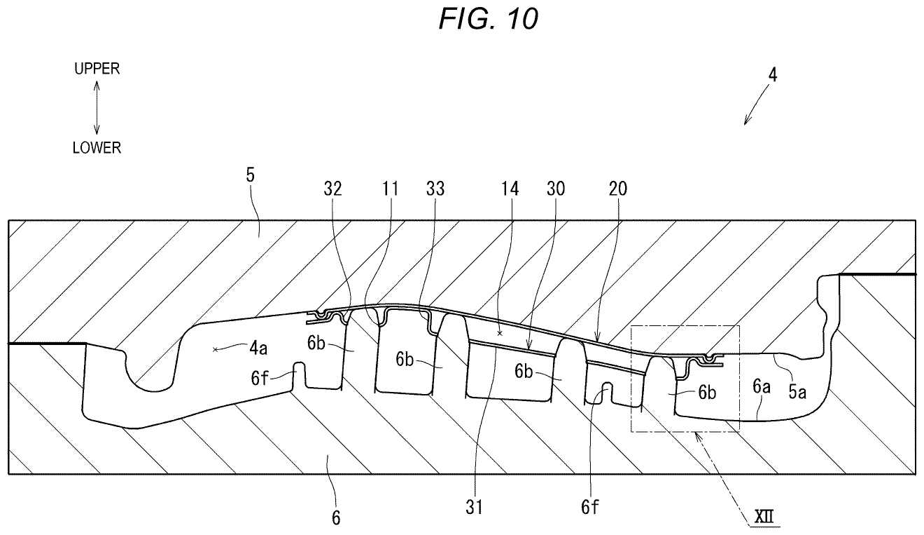

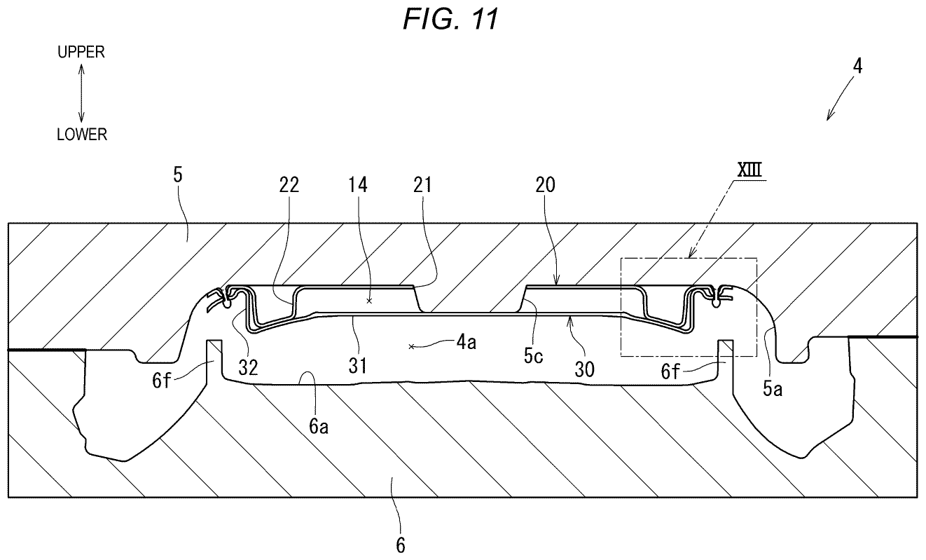

The pad body 10 is formed of a polyurethane foaming molded body. As shown in FIGS. 10 and 11, the pad body 10 is formed by foaming and molding a foaming raw material poured into a cavity 4a in a mold 4. The flow passage cover 20 and the duct 30 are set in the cavity 4a when the pad body 10 is foamed and molded. Therefore, the flow passage cover 20 and the duct 30 are integrated with the pad body 10 as the pad body 10 is foamed and mol ded.

Accordingly, the flow passage cover 20 and the duct 30 can be easily provided to the pad body 10. In addition, the flow passage cover 20 can be appropriately disposed at an alignment position to the duct 30 and the pad body 10.

When the flow passage cover 20 is misaligned from the alignment position to the duct 30 and the pad body 10, the opening hole 21 of the flow passage cover 20 is misaligned with respect to the air flow passage 14 and the blower. Then, ventilation performance of the cushion pad 2 may be deteriorated. Therefore, by disposing the flow passage cover 20 at an appropriate position with respect to the duct 30 and the pad body 10, the ventilation performance of the cushion pad 2 can be appropriately maintained.

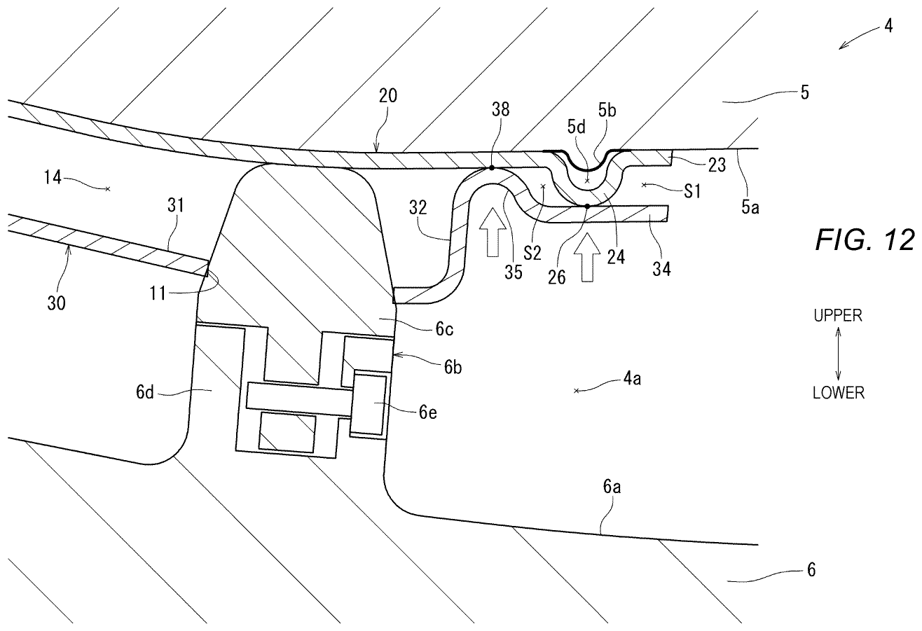

As shown in FIG. 12, the flow passage cover 20 has a cover bent portion 24 that bends to protrude from a peripheral edge portion 23 toward the duct 30. A first gap S1 is formed between the flow passage cover 20 and the duct 30 by a protruding shape of the cover bent portion 24. The foaming raw material of the pad body 10 actively flows into the first gap S1.

Accordingly, the flow passage cover 20 and the duct 30 can be appropriately integrated with the pad body 10.

The cover bent portion 24 has a first abutment portion 26 that abuts against the duct 30 at a protruding tip end. Therefore, it is possible to prevent the foaming raw material that has flowed into the first gap S1 from entering an inner side in an in-plane direction beyond the cover bent portion 24. Accordingly, it is possible to prevent the foaming raw material from leaking into the air flow passage 14 between the flow passage cover 20 and the duct 30.

The cover bent portion 24 is set such that a recess of the cover bent portion 24 on the seat back side faces a back side molding surface 5a of an upper mold 5. The cover bent portion 24 receives a foaming pressure of the foaming raw material when the pad body 10 is foamed and molded. Accordingly, a base end of the cover bent portion 24 is strongly pressed against the back side molding surface 5a. Therefore, it is possible to prevent the foaming raw material from entering a portion between the flow passage cover 20 and the back side molding surface 5a. As described above, the foaming raw material is prevented from leaking into a gap between the flow passage cover 20 and the duct 30 and a gap between the flow passage cover 20 and the back side molding surface 5a, and a molding failure can be appropriately prevented.

### <Seat Cushion 1>

Hereinafter, configurations of the seat cushion 1 and the mold 4 will be described in detail. As shown in FIG. 1, the seat cushion 1 includes a cushion frame (not shown) forming a framework of the seat cushion 1, the cushion pad 2 assembled to the cushion frame from above, and a cushion cover 3 covering the cushion pad 2 from above. The cushion cover 3 is turned downward of the cushion pad 2 and engaged with the cushion frame. Accordingly, the cushion pad 2 is integrally assembled to the cushion frame. The blower is attached to the cushion frame. The blower is connected to the opening hole 21 of the flow passage cover 20 by being assembled to the cushion frame of the cushion pad 2 (see FIG. 2).

### <Cushion Pad 2>

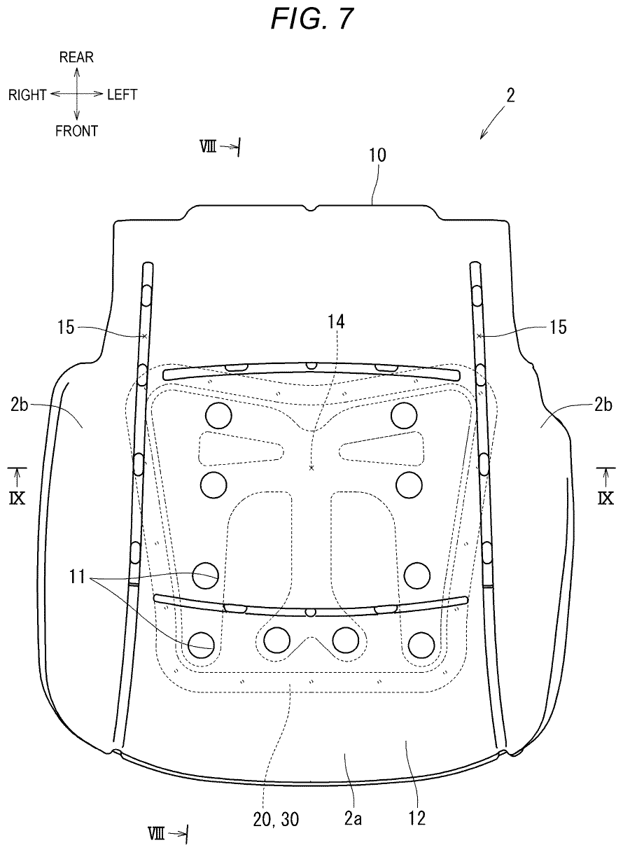

As shown in FIG. 7, the cushion pad 2 includes a main top plate 2a that supports the buttocks of the seated person from below, and a pair of left and right side top plates 2b that support the buttocks of the seated person from both left and right sides. The cushion pad 2 has a plurality of suspension grooves 15 extending along a pad front surface 12. The suspension grooves 15 includes a pair of left and right suspension grooves located between the main top plate 2a and the side top plate 2b, and a pair of front and rear suspension grooves extending left and right along the main top plate 2a. A top plate portion of the cushion cover 3 is suspended and engaged in each of the suspension grooves 15. Accordingly, the cushion cover 3 is stretched in a state of being in close contact with the cushion pad 2 (see FIG. 1).

### <Duct 30>

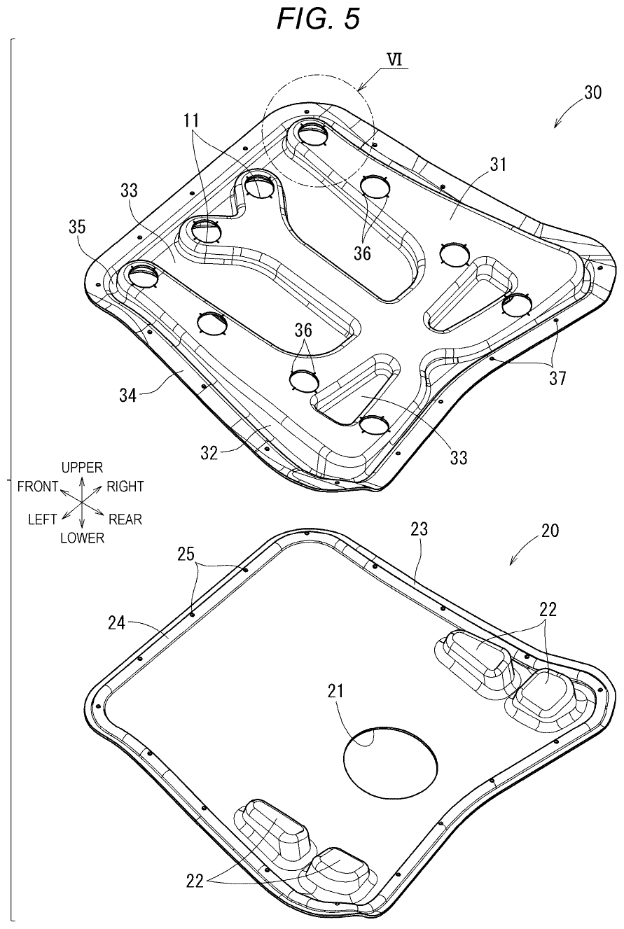

As shown in FIGS. 4 and 5, the duct 30 is a substantially rectangular member provided along an entire region of the air flow passage 14. The duct 30 includes a bottom portion 31 forming a bottom surface of the air flow passage 14, a side wall portion 32 rising from a peripheral edge of the bottom portion 31 to form a side surface of the air flow passage 14, and partition portions 33 protruding from the bottom portion 31 to partially partition the air flow passage 14. The air flow passage 14 is formed in a groove shape extending to branch in a plurality of directions by the partition portions 33.

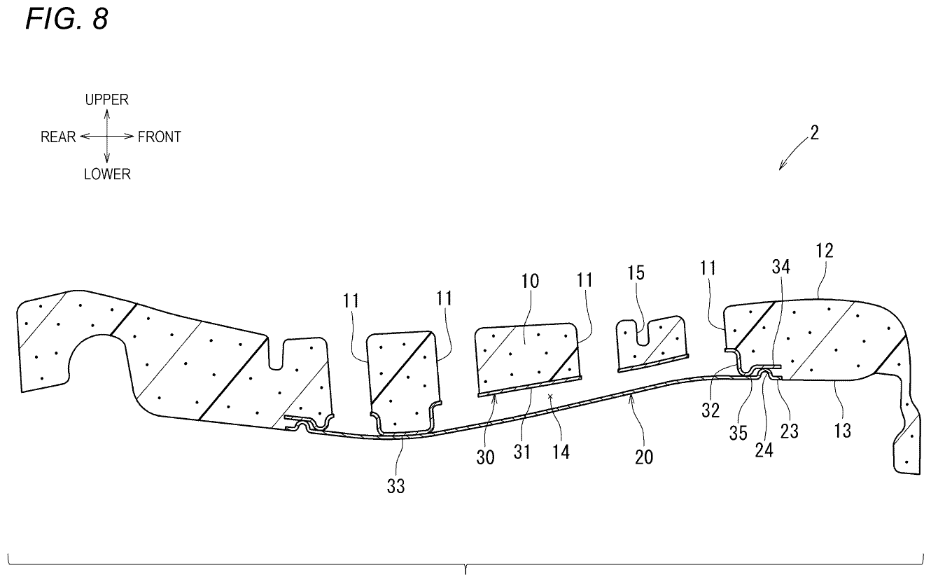

As shown in FIGS. 5 and 8, the duct 30 includes a seat surface portion 34 overhanging in a flange shape from an end of the side wall portion 32 toward the outside in the in-plane direction. The seat surface portion 34 is formed to extend along a region of the pad back surface 13 which is outside the air flow passage 14. The seat surface portion 34 includes, between the seat surface portion 34 and the side wall portion 32, a duct bent portion 35 that curves to protrude toward the seat back side. The duct bent portion 35 is formed to extend in an endless manner over an entire peripheral edge of the duct 30. The duct bent portion 35 is curved in a U-shape in cross section toward the seat back side. The seat surface portion 34 has a plurality of duct through holes 37 penetrating the seat surface portion 34 in the thickness direction. The duct through holes 37 are arranged at predetermined intervals in a manner of aligning along the entire peripheral edge of the duct 30.

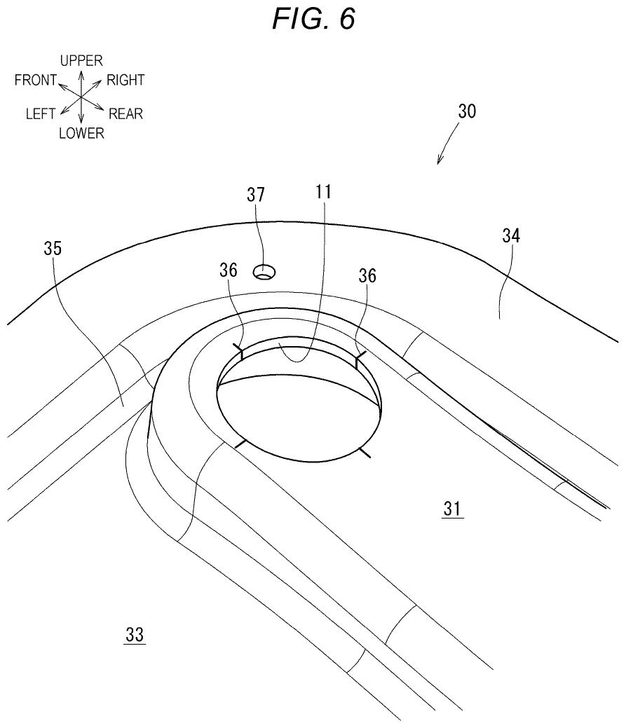

As shown in FIGS. 5 and 6, the vent holes 11 are opened from various places in the bottom portion 31. The duct 30 has slits 36 extending from a peripheral edge of each vent hole 11 in a hole diameter direction at four locations around each vent hole 11. As shown in FIG. 12, each of hole forming protrusions 6b for forming the vent hole 11 of the pad body 10 is inserted into the vent hole 11 of the duct 30 set in the mold 4. A variation in installation that occurs when the hole forming protrusion 6b is inserted can be absorbed by each of the slits 36. Accordingly, the hole forming protrusion 6b can be appropriately inserted into the vent hole 11.

### <Flow Passage Cover 20>

As shown in FIGS. 3 and 5, the flow passage cover 20 is a substantially rectangular member extending along the shape of the duct 30. The flow passage cover 20 is provided to cover an entire region of the duct 30 from the seat back side. The flow passage cover 20 is a molded nonwoven fabric that is press-molded into a predetermined shape in advance. The flow passage cover 20 has cover side support portions 22 protruding toward a seat front side on both sides in the seat width direction of a rear portion of the flow passage cover 20. The flow passage cover 20 has the cover bent portion 24 that bends to protrude from the peripheral edge portion 23 toward the seat front side. The cover bent portion 24 is formed to extend in an endless manner over an entire peripheral edge of the flow passage cover 20. The cover bent portion 24 is formed to protrude from a position that is located on the inner side with respect to the outer peripheral edge of the flow passage cover 20 in the in-plane direction.

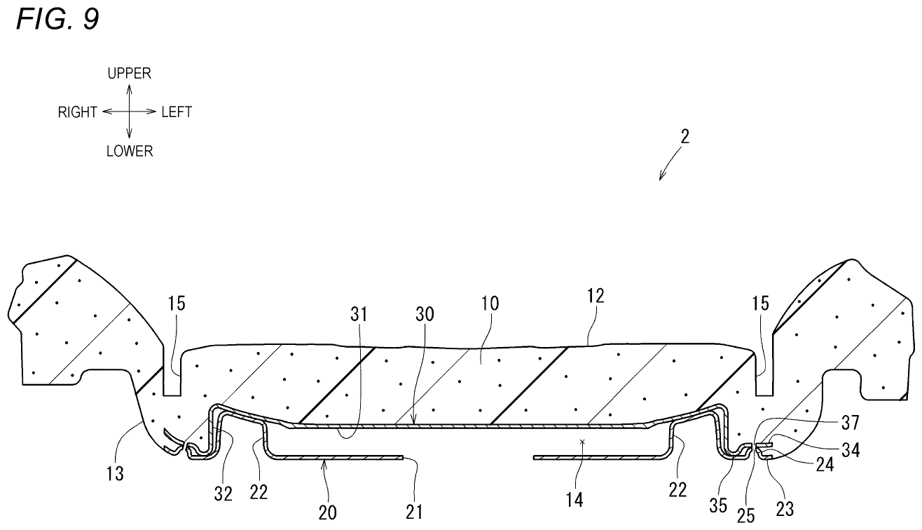

The flow passage cover 20 has a plurality of cover through holes 25 penetrating the cover bent portion 24 in the thickness direction. The cover through holes 25 are arranged at predetermined intervals in a manner of aligning along the entire peripheral edge of the flow passage cover 20. As shown in FIG. 9, the cover bent portion 24 is curved in a U-shape in cross section toward the seat front side. Each of the cover through holes 25 is formed to open from a protruding tip end of the cover bent portion 24.

### <Mold 4>

As shown in FIGS. 10 and 11, the mold 4 includes the upper mold 5 and a lower mold 6 which are made of metal and face each other in the upper-lower direction. The upper mold 5 and the lower mold 6 can be separated from each other. For example, the upper mold 5 is configured to be movable in the upper-lower direction. The upper mold 5 and the lower mold 6 form a cavity 4a between the molding surface 5a and a molding surface 6a by clamping the upper mold 5 and the lower mold 6. The cavity 4a forms a shape of an outer peripheral surface of the pad body 10. The flow passage cover 20 is set on the upper mold 5 in an overlapping manner from below. Then, the duct 30 is set to the set flow passage cover 20 in an overlapping manner from below.

### <Upper Mold 5>

The upper mold 5 has the back side molding surface 5a formed on a lower surface of the upper mold 5. The back side molding surface 5a forms a surface shape of the pad back surface 13 of the pad body 10. As shown in FIG. 11, the upper mold 5 has a mold side support portion 5c that protrudes from the back side molding surface 5a in a trapezoidal shape in cross section. The mold side support portion 5c passes through the opening hole 21 of the flow passage cover 20 by setting the flow passage cover 20. The mold side support portion 5c is brought into contact with the bottom portion 31 of the duct 30 from above by setting the duct 30. Accordingly, the duct 30 can be prevented from being crushed upward by a foaming pressure of the foaming raw material. As a result, the air flow passage 14 can be prevented from being narrowed.

As shown in FIG. 12, the upper mold 5 has a bank portion 5b protruding from the back side molding surface 5a. The bank portion 5b enters the recess of the cover bent portion 24 by setting the flow passage cover 20. The bank portion 5b is formed to enter an entire region in an extension direction of the cover bent portion 24. The bank portion 5b forms a bank that blocks the foaming raw material when the foaming raw material leaks into a gap between the flow passage cover 20 and the back side molding surface 5a. Accordingly, it is possible to prevent the foaming raw material from entering the inner side in the in-plane direction beyond the bank portion 5b. Here, the back side molding surface 5a corresponds to a “molding surface” in the present invention.

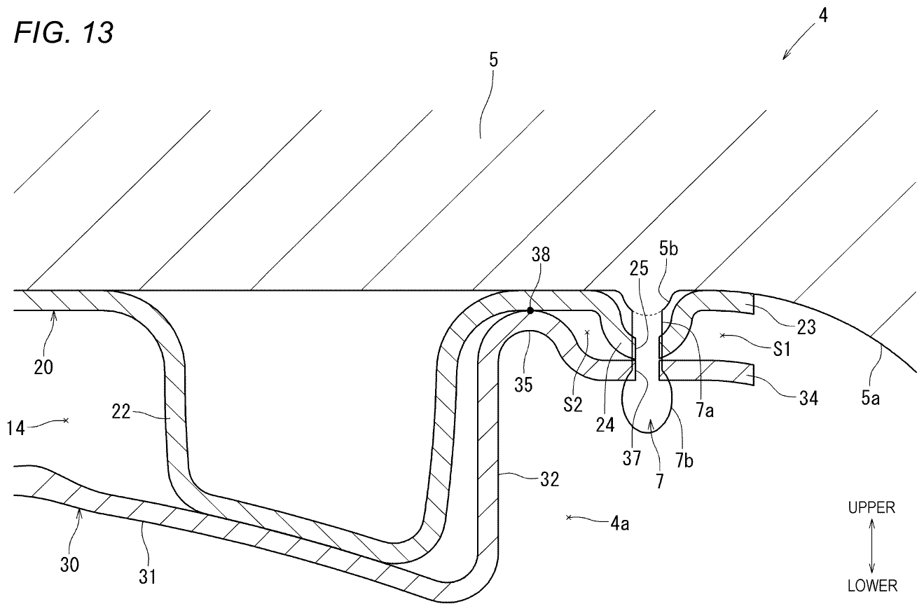

The bank portion 5b is provided to form an interval 5d between the bank portion 5b and the cover bent portion 24. Accordingly, when the flow passage cover 20 is set on the back side molding surface 5a, it is possible to prevent the bank portion 5b from interfering with the cover bent portion 24. Accordingly, it is possible to prevent the bank portion 5b from pressing the cover bent portion 24 due to a variation in installation of the flow passage cover 20, and prevent the flow passage cover 20 from being lifted from the back side molding surface 5a. That is, the flow passage cover 20 can be set in a state of appropriately overlapping with the back side molding surface 5a. Therefore, it is possible to prevent the foaming raw material from leaking into the gap between the flow passage cover 20 and the back side molding surface 5a. As shown in FIG. 13, the upper mold 5 includes a plurality of set pins 7 that hold the set flow passage cover 20 and duct 30 on the back side molding surface 5a. Each of the set pins 7 includes a shaft portion 7a that is attached to protrude downward from a tip end of the bank portion 5b, and a retaining portion 7b that has a diameter larger than that of the shaft portion 7a and that is formed at a tip end of the shaft portion 7a. The shaft portion 7a is attached, for example, by screwing into a screw hole provided in the bank portion 5b. Each set pin 7 is provided at a position corresponding to the cover through hole 25 of the flow passage cover 20. The set pin 7 passes through the cover through hole 25 from below by setting the flow passage cover 20. Accordingly, the cover through hole 25 is passed over and is hooked onto the retaining portion 7b of the set pin 7 in a setting direction. The flow passage cover 20 is retained with respect to the set pins 7 by the hooking. Accordingly, the flow passage cover 20 is held so as not to fall off.

The set pin 7 also passes through the duct through hole 37 of the seat surface portion 34 of the duct 30 from below by setting the duct 30. Accordingly, the duct through hole 37 is passed over and is hooked onto the retaining portion 7b of the set pin 7 in the setting direction. The seat surface portion 34 engaged with the set pin 7 is pressed against the cover bent portion 24. The cover bent portion 24 is sandwiched between the back side molding surface Sa and the seat surface portion 34 to generate a resilient force. Against this resilient force, the retaining portion 7b strongly presses the base end of the cover bent portion 24 against the back side molding surface 5a. Accordingly, it is difficult to form a gap between the flow passage cover 20 and the back side molding surface 5a. Here, the set pin 7 corresponds to an “engagement portion” in the present invention. The cover through hole 25 and the duct through hole 37 correspond to “through holes” in the present invention.

### <Lower Mold 6>

As shown in FIGS. 10 and 11, the lower mold 6 has a front side molding surface 6a formed on an upper surface of the lower mold 6. The front side molding surface 6a forms a surface shape of the pad front surface 12 of the pad body 10. The lower mold 6 has a plurality of groove forming protrusions 6f protruding from the front side molding surface 6a. Each of the groove forming protrusions 6f forms a shape of an inner peripheral surface of the suspension groove 15. The lower mold 6 has the plurality of hole forming protrusions 6b protruding from the front side molding surface 6a. As shown in FIG. 12, the hole forming protrusion 6b includes a base portion 6d protruding from the front side molding surface 6a and a tip end portion 6c removably attached to a tip end of the base portion 6d.

The tip end portion 6c is fixed to the base portion 6d by a bolt 6e. The tip end portion 6c has a circular truncated cone shape extending in a tapered shape. The tip end portion 6c is inserted into the vent hole 11 of the duct 30 from below by clamping the upper mold 5 and the lower mold 6. The tip end portion 6c is in close contact with the peripheral edge of the vent hole 11 so as not to form a gap by the tapered shape. Accordingly, it is possible to prevent the foaming raw material from leaking from the vent holes 11 into the air flow passage 14.

The tip end portions 6c are brought into contact with the flow passage cover 20 from below. Accordingly, the flow passage cover 20 can be held to be less likely to be misaligned with respect to the back side molding surface 5a. Since the tip end portion 6c is configured to be removable, the other tip end portion 6c can be attached to the base portion 6d of the hole forming protrusion 6b. For example, it is possible to attach the tip end portion 6c whose taper angle is larger or smaller, or to attach the tip end portion 6c having a different diameter. Accordingly, it is possible to easily deal with the ducts 30 in which the vent holes 11 have different hole diameters.

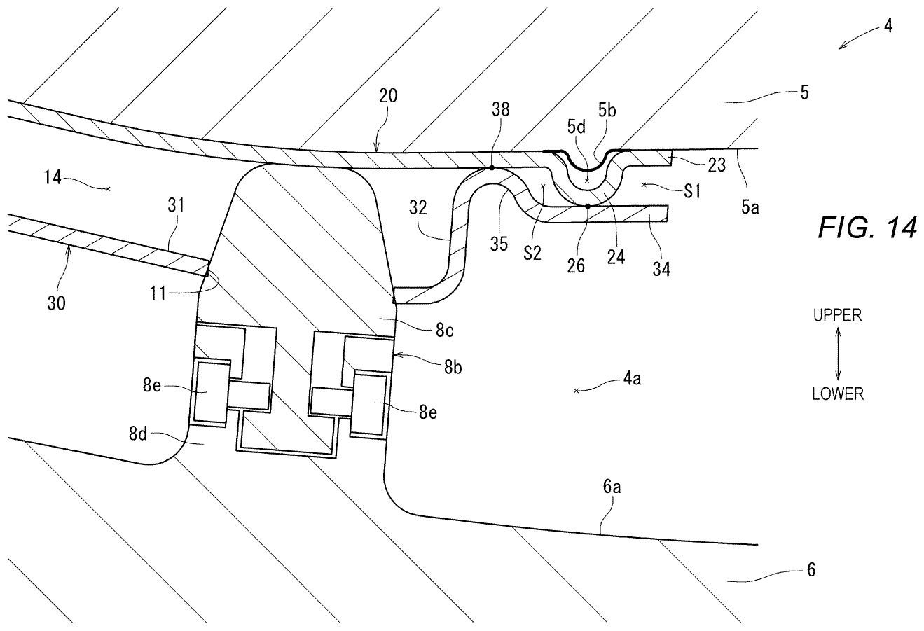

In yet another embodiment, as shown in FIG. 14, the lower mold 6 may have hole forming protrusions 8b. A tip end portion 8c of the hole forming protrusion 8b is fixed to a base portion 8d by a plurality of bolts 8e that are inserted along a radial direction of the base portion 8d. Accordingly, arrangement in the radial direction of the tip end portion 8c can be adjusted by adjusting a tightening degree of each of the bolts 8e. Accordingly, a variation in installation of the duct 30 can be further absorbed, and the tip end portion 8c can be appropriately brought into close contact with the vent hole 11.

<Overlap between Flow Passage Cover 20 and Duct 30>

As shown in FIG. 12, the first gap S1 opening toward the outside is formed between the peripheral edge portion 23 of the flow passage cover 20 and the seat surface portion 34 by the cover bent portion 24. The foaming raw material actively flows into the first gap S1 when the pad body 10 is molded. Therefore, the pad body 10 is formed to be integrated with each of the peripheral edge portion 23 and the seat surface portion 34 therebetween. Accordingly, the flow passage cover 20 and the duct 30 can be appropriately integrated with the pad body 10. Here, the first gap S1 corresponds to a “gap” in the present invention.

The cover bent portion 24 has the first abutment portion 26 that abuts against the seat surface portion 34 of the duct 30 by setting the duct 30. The first abutment portion 26 is brought into linear contact with the seat surface portion 34 on the entire peripheral edge of the flow passage cover 20 along the extension direction of the cover bent portion 24. It is possible to prevent, by the first abutment portion 26, the foaming raw material that has flowed into the first gap S1 from leaking into the gap between the flow passage cover 20 and the duct 30 beyond the cover bent portion 24.

The duct bent portion 35 of the seat surface portion 34 has a second abutment portion 38 that abuts against the flow passage cover 20 by setting the duct 30. The second abutment portion 38 is brought into linear contact with the flow passage cover 20 on the entire peripheral edge of the duct 30 along an extension direction of the duct bent portion 35. The second abutment portion 38 is formed on the inner side with respect to the first abutment portion 26 in the in-plane direction. A second gap S2 is formed between the first abutment portion 26 and the second abutment portion 38. The second gap S2 forms a space for retaining the foaming raw material when the foaming raw material leaks into the inner side beyond the first abutment portion 26. Moreover, the duct bent portion 35 and the cover bent portion 24 are arranged to protrude alternately. Therefore, the duct bent portion 35 forms a bank that blocks the foaming raw material that has flowed into the second gap S2. Accordingly, it is possible to more appropriately prevent the foaming raw material from leaking into the air flow passage 14 beyond the second abutment portion 38.

As shown in FIG. 13, the cover side support portion 22 of the flow passage cover 20 is brought into contact with the bottom portion 31 of the duct 30 from above by setting the duct 30. Accordingly, the duct 30 can be prevented from being crushed upward by the foaming pressure of the foaming raw material. As a result, the air flow passage 14 can be prevented from being narrowed. Further, the abutment portions 26 and 38 of the flow passage cover 20 and the duct 30 can be prevented from being separated from each other during molding by preventing deformation of the duct 30. Accordingly, it is possible to more appropriately prevent the foaming raw material from leaking into the air flow passage 14. Here, the cover side support portion 22 corresponds to a “support portion” in the present invention.

### <Method for Manufacturing Pad Body 10>

Hereinafter, a procedure for manufacturing the pad body 10 will be described. At First, the flow passage cover 20 and the duct 30 are formed into the predetermined shapes in advance by press molding. The upper mold 5 and the lower mold 6 are in a state of not being clamped to each other. First, the flow passage cover 20 is set on the back side molding surface 5a of the upper mold 5 in the overlapping manner. As shown in FIG. 13, the set pin 7 passes through the cover through hole 25 of the cover bent portion 24. The bank portion 5b of the upper mold 5 enters the recess of the cover bent portion 24. As shown in FIG. 11, the mold side support portion 5c of the upper mold 5 passes through the opening hole 21 of the flow passage cover 20 (see FIG. 11).

Next, the duct 30 is set to the set flow passage cover 20 in the overlapping manner. As shown in FIG. 13, the set pin 7 passes through the duct through hole 37 of the seat surface portion 34. Accordingly, a tip end of the duct bent portion 35 is pressed against the flow passage cover 20 (the second abutment portion 38). As shown in FIG. 12, the seat surface portion 34 is pressed against the tip end of the cover bent portion 24 (first abutment portion 26). Then, the base end of the cover bent portion 24 is pressed against the back side molding surface 5a. The first gap S1 and the second gap S2 are formed between the flow passage cover 20 and the duct 30. As shown in FIG. 11, the cover side support portions 22 of the flow passage cover 20 and the mold side support portion 5c of the upper mold 5 are brought into contact with the bottom portion 31 of the duct 30 from above.

Next, as shown in FIGS. 10 and 11, the upper mold 5 and the lower mold 6 are clamped to each other. Accordingly, the cavity 4a for molding the pad body 10 is formed. The hole forming protrusion 6b of the lower mold 6 passes through the vent hole 11 of the duct 30 and is brought into contact with the flow passage cover 20. Then, the foaming raw material is poured into the cavity 4a to foam and mold the pad body 10. The pad front surface 12 is formed by the front side molding surface 6a. The pad back surface 13 is formed by the back side molding surface 5a. The vent hole 11 penetrating the pad body 10 is formed by the hole forming protrusion 6b. The suspension groove 15 is formed by the groove forming protrusion 6f.

As shown in FIGS. 12 and 13, the foaming raw material flows into the first gap S1, and the peripheral edge portion 23 of the flow passage cover 20 and the seat surface portion 34 of the duct 30 are integrated with the pad body 10. In addition, the seat surface portion 34 is pressed toward the flow passage cover 20 by the foaming pressure. Therefore, the seat surface portion 34 is more strongly pressed against the first abutment portion 26. The second abutment portion 38 is more strongly pressed against the flow passage cover 20. Accordingly, it is possible to more appropriately prevent the foaming raw material from entering the air flow passage 14 from a gap between the flow passage cover 20 and the duct 30. Further, the base end of the cover bent portion 24 is more strongly pressed against the back side molding surface 5a. Accordingly, it is possible to more appropriately prevent the foaming raw material from entering a portion between the flow passage cover 20 and the back side molding surface 5a. In this manner, the flow passage cover 20 and the duct 30 can be appropriately integrated with the pad body 10 while preventing the leakage of the foaming raw material.

In summary, the seat pad and the mold for the seat pad according to the first embodiment have the following configuration. In the following description, reference signs assigned in parentheses correspond to the configurations described in the embodiment described above.

That is, a seat pad (2) includes: a pad body (10) including a recessed air flow passage (14) extending along a pad back surface (13); a planar duct (30) configured to be provided along the pad back surface (13) to form an inner peripheral wall of the air flow passage (14); and a planar flow passage cover (20) configured to cover the duct (30) from the seat back side and configured to cover the air flow passage (14). The duct (30) and the flow passage cover (20) are molded in predetermined shapes in advance, and are configured to be foamed and molded integrally with the pad body (10). The flow passage cover (20) is configured to be set on a molding surface (5a) of a mold (4) for the pad body (10) in an overlapping manner, and has a cover bent portion (24) bent toward a seat front side to form, at a peripheral edge portion (23) of the flow passage cover (20), a recess capable of receiving a bank portion (5b) that protrudes from the molding surface (5a). the duct (30) includes a seat surface portion (34) extending along a region of the pad back surface (13) which is outside the air flow passage (14). With respect to the flow passage cover (20) to be set on the molding surface (5a), the seat surface portion (34) is configured to be brought into contact with a protruding tip end of the cover bent portion (24) to form a gap (S1) into which a foaming raw material of the pad body (10) is to flow.

According to the above configuration, the flow passage cover (20) and the duct (30) are appropriately integrated with the pad body (10) by the flowing the foaming raw material into the gap between the flow passage cover (20) and the duct (30). Accordingly, the misalignment of the flow passage cover (20) with respect to the duct (30) can be prevented. By the contact between the cover bent portion (24) and the seat surface portion (34), it is possible to prevent the foaming raw material from entering a portion between the flow passage cover (20) and the duct (30) beyond the cover bent portion (24). The recess on the seat back side of the cover bent portion (24) is set to face the molding surface (5a), and the bank portion (5b) of the molding surface (5a) enters the recess of the cover bent portion (24). Therefore, even when the foaming raw material leaks into the gap between the flow passage cover (20) and the molding surface (5a), the bank portion (5b) can block the leaking foaming raw material. Accordingly, it is possible to prevent the foaming raw material from entering the inner side beyond the bank portion (5b). As a result, it is possible to appropriately prevent a molding failure caused by the leakage of the foaming raw material.

The seat surface portion (34) includes a duct bent portion (35) that is on an inner side in an in-plane direction with respect to the cover bent portion (24) and that is bent to protrude toward the seat back side to be brought into contact with the flow passage cover (20). According to the above configuration, the duct bent portion (35) of the seat surface portion (34) is brought into contact with the flow passage cover (20) on the inner side in the in-plane direction with respect to the cover bent portion (24). Accordingly, even when the foaming raw material enters the inner side beyond the contact between the cover bent portion (24) and the seat surface portion (34), it is possible to prevent the foaming raw material from further entering the inner side by the contact between the duct bent portion (35) and the flow passage cover (20). Moreover, the duct bent portion (35) and the cover bent portion (24) protrude alternately. Therefore, a rising shape of the duct bent portion (35) can block the foaming raw material. As a result, it is possible to further prevent the foaming raw material from entering the air flow passage (14).

The cover bent portion (24) extends in an endless manner over an entire peripheral edge of the flow passage cover (20). According to the above configuration, it is possible to prevent the foaming raw material from leaking into a gap between the flow passage cover (20) and the duct (30) and a gap between the flow passage cover (20) and the mold (4) over the entire peripheral edge of the flow passage cover (20).

The flow passage cover (20) includes a support portion (22) protruding into the air flow passage (14) to be brought into contact, from the seat back side, with a bottom portion (31) that forms a bottom surface of the air flow passage (14) of the duct (30). According to the above configuration, the support portion (22) can prevent deformation of the duct (30) due to a foaming pressure. Accordingly, it is possible to prevent the contact between the cover bent portion (24) and the seat surface portion (34) from collapsing. As a result, it is possible to appropriately prevent the foaming raw material from entering the air flow passage (14).

The mold (4) includes an engagement portion (7) configured to protrude from the bank portion (5b) and configured to pass through through holes (25, 37) formed in the tip end of the cover bent portion (24) and the seat surface portion (34) to engage with the seat surface portion (34) so as to press the base end of the cover bent portion (24) against the molding surface (5a) against a resilient force of the cover bent portion (24). According to the above configuration, the engagement portion (7) strongly presses the seat surface portion (34) against the cover bent portion (24), and strongly presses the cover bent portion (24) against the molding surface (5a). Accordingly, it is possible to more appropriately prevent the foaming raw material from leaking.

The bank portion (5b) is provided at an interval (5d) from the cover bent portion (24) so as not to interfere with the cover bent portion (24) in an initial state in which the flow passage cover (20) is set. In the case of a configuration in which the bank portion (5b) interferes with the cover bent portion (24) in the initial state, the bank portion (5b) presses the cover bent portion (24) due to a variation in installation, and the flow passage cover (20) may be lifted from the molding surface (5a). However, according to the above configuration, the flow passage cover (20) can be set in a state of appropriately overlapping with the molding surface (5a) without causing the bank portion (5b) to interfere with the cover bent portion (24). Accordingly, it is possible to more appropriately prevent the foaming raw material from leaking into a gap between the flow passage cover (20) and the mold (4).

### OTHER EMBODIMENTS

The present invention has been described with reference to one embodiment, whereas the present invention can be implemented in various forms other than the above embodiment.
1. The seat pad can also be applied to a seat back in addition to the seat cushion. The seat pad can be widely applied to seats provided for various vehicles, for example, a vehicle other than an automobile such as a railway, an aircraft, and a ship, in addition to the seat of the automobile.
2. The cover bent portion and the duct bent portion may not be configured to extend over the entire peripheral edge, and may be configured to be formed only in a portion along the outer peripheral edge. The cover bent portion and the duct bent portion may be configured to extend intermittently.
3. In the mold, the flow passage cover and the duct may be set in the lower mold. The bank portion may be formed to be in close contact with the recess of the cover bent portion without the interval therebetween.
4. The set pin may be attached to a set mold to pass the through holes after setting the flow passage cover and the duct.

What is claimed is:

1. A seat pad comprising:
a pad body including a recessed air flow passage extending along a pad back surface;
a planar duct configured to be provided along the pad back surface to form an inner peripheral wall of the air flow passage; and
a planar flow passage cover configured to cover the duct from a seat back side and configured to cover the air flow passage, wherein
the duct and the flow passage cover are molded in predetermined shapes in advance, and are configured to be foamed and molded integrally with the pad body,
the flow passage cover is configured to be set on a molding surface of a mold for the pad body in an overlapping manner, and has a cover bent portion bent toward a seat front side to form, at a peripheral edge portion of the flow passage cover, a recess capable of receiving a bank portion that protrudes from the molding surface, and
the duct includes a seat surface portion extending along a region of the pad back surface which is outside the air flow passage, and with respect to the flow passage cover to be set on the molding surface, the seat surface portion is configured to be brought into contact with a protruding tip end of the cover bent portion to form a gap into which a foaming raw material of the pad body is to flow.

2. The seat pad according to claim 1, wherein
the seat surface portion includes a duct bent portion that is on an inner side in an in-plane direction with respect to the cover bent portion and that is bent to protrude toward the seat back side to be brought into contact with the flow passage cover.

3. The seat pad according to claim 1, wherein
the cover bent portion extends in an endless manner over an entire peripheral edge of the flow passage cover.

4. The seat pad according to claim 2, wherein
the cover bent portion extends in an endless manner over an entire peripheral edge of the flow passage cover.

5. The seat pad according to claim 1, wherein
the flow passage cover includes a support portion protruding into the air flow passage to be brought into contact, from the seat back side, with a bottom portion that forms a bottom surface of the air flow passage of the duct.

6. The seat pad according to claim 2, wherein
the flow passage cover includes a support portion protruding into the air flow passage to be brought into contact, from the seat back side, with a bottom portion that forms a bottom surface of the air flow passage of the duct.

7. A mold for molding the seat pad according to claim 1, the mold comprising:
an engagement portion configured to protrude from the bank portion and configured to pass through through holes formed in the tip end of the cover bent portion and the seat surface portion to engage with the seat surface portion so as to press the base end of the cover bent portion against the molding surface against a resilient force of the cover bent portion.

8. A mold for molding the seat pad according to claim 2, the mold comprising:
an engagement portion configured to protrude from the bank portion and configured to pass through through holes formed in the tip end of the cover bent portion and the seat surface portion to engage with the seat surface portion so as to press the base end of the cover bent portion against the molding surface against a resilient force of the cover bent portion.

9. A mold for molding the seat pad according to claim 1, wherein
the bank portion is provided at an interval from the cover bent portion so as not to interfere with the cover bent portion in an initial state in which the flow passage cover is set.

10. A mold for molding the seat pad according to claim 2, wherein
the bank portion is provided at an interval from the cover bent portion so as not to interfere with the cover bent portion in an initial state in which the flow passage cover is set.
